(19) United States
(12) Patent Application Publication
(10) Pub. No.: US 2013/0028042 A1
(43) Pub. Date: Jan. 31, 2013

(54) METHOD FOR CALIBRATING APPARATUS FOR MEASURING SHAPE FACTOR

(71) Applicants: Robert J. Pruett, Milledgeville, GA (US); Jondahl Davis, Sandersville, GA (US); Roger Wygant, East Dublin, GA (US)

(72) Inventors: Robert J. Pruett, Milledgeville, GA (US); Jondahl Davis, Sandersville, GA (US); Roger Wygant, East Dublin, GA (US)

(73) Assignee: Imerys Pigments, Inc., Roswell, GA (US)

(21) Appl. No.: 13/389,698

(22) PCT Filed: Jan. 30, 2012
(86) PCT No.: PCT/US12/23107

§ 371 Date: Feb. 9, 2012

Related U.S. Application Data
(60) Provisional application No. 61/512,670, filed on Jul. 28, 2011.

(51) Int. Cl. G05D 11/13; G01N 27/06; G01N 23/00; G01D 18/00

(52) U.S. Cl. 366/152.4; 73/1.01; 324/693; 250/311

(57) ABSTRACT

A method for calibrating an apparatus for measuring shape factor is provided, wherein the method comprises determining aspect ratios for each of a plurality of kaolin samples and measuring the shape factors of each of the plurality of kaolin samples using the apparatus, wherein each of the kaolin samples includes potassium oxide in an amount less than about 0.1% by weight of each of the kaolin samples. The method further includes calibrating the apparatus based on a correlation between the aspect ratios and the shape factors.

### CLAIM FOR PRIORITY/INCORPORATION BY REFERENCE

This PCT international application claims the benefits of priority to, and incorporates by reference herein in its entirety, U.S. Provisional Patent Application No. 61/512,670, filed Jul. 28, 2011.

### FIELD OF THE DESCRIPTION

This description relates to an apparatus and a method for measuring the average (or apparent) aspect ratio, or shape factor, of non-spherical particles in a fluid suspension. In particular, this description relates to a method for calibrating an apparatus for measuring the shape factor of particles in a fluid suspension.

### BACKGROUND OF THE INVENTION

In many applications of particulate solid materials, the aspect ratio of the particles of the material is a parameter that may profoundly affect the performance of the material. For example, if the particulate material is used in a composition for coating paper, the surface finish of the paper may be determined to a large degree by the average aspect ratio, or shape factor, of the particles. If it is desired to produce a coated paper that has a smooth, glossy finish, the particulate material may need a different shape factor from that required if the coated paper is to have a matt surface with greater ink absorbency.

An example of a particle is shown in FIG. 1, which helps to illustrate the meaning of the expression “aspect ratio” as used in this application (in contrast to “average aspect ratio” or “shape factor”). The expression “aspect ratio” means “the diameter of the circle of area equivalent to that of a face of the particle divided by the mean thickness of that particle.” Aspect ratio may be determined using electron microscopy methods. An exemplary kaolin particle P is shown in FIG. 1 with a superimposed circle having an area equivalent to that of the face of the particle P. The diameter of that circle is d, the thickness of the particle is t, and the aspect ratio of the particle is d divided by t.

In contrast to aspect ratio, it has previously been found that the average aspect ratio of particles in a suspension, or shape factor, may be calculated from a measurement of the conductivity of the suspension. In British Patent Application No. 9101291.4 (Publication No. 2240398), a method and apparatus are described for obtaining a measurement indicative of the average aspect ratio of non-spherical particles in suspension. According to this method, the conductivity of the suspension is measured between points for two different orientations of the particles in suspension, and the difference between the two measured conductivities is used as an indication of the average particle aspect ratio. The particle orientation may be aligned for the first conductivity measurement and may be aligned transverse to the first orientation direction, or have random alignment, for the second conductivity measurement.

According to another method disclosed in U.S. Pat. No. 5,576,617, the subject matter of which is incorporated herein by reference, an apparatus may be used to measure the shape factor of non-spherical particles by obtaining a fully-deflocculated suspension of the particles, causing the particles in the suspension to orientate generally in a first direction, measuring the conductivity of the particles suspension substantially in the first direction, and simultaneously or substantially simultaneously measuring the conductivity of the particle suspension in a direction transverse to the first direction. Thereafter, the difference between the two conductivity measurements may be determined to provide a measure of the shape factor of the particles in suspension. Measuring conductivity “substantially simultaneously” means to take the second conductivity measurement sufficiently close in time after the first conductivity measurement, such that the temperature of the suspension being measured will be effectively the same for each measurement.

There was previously no known relationship between aspect ratio and shape factor since the values obtained in connection with the measurement of each are derived from wholly distinct measurement techniques and are not clearly connected. Aspect ratio and shape factor relate to distinct characteristics, and thus, calibrating the above-described apparatus for measuring shape factor required the use of kaolin samples having known shape factors (i.e., kaolin standards). Therefore, it would be desirable to determine an alternative method for calibrating an apparatus for measuring shape factor.

### SUMMARY

In accordance with a first aspect, a method for calibrating an apparatus for measuring shape factor is provided, wherein the method comprises determining aspect ratios for each of a plurality of kaolin samples and measuring the shape factors of each of the plurality of kaolin samples using the apparatus, wherein each of the kaolin samples includes potassium oxide in an amount less than about 0.1% by weight of each of the kaolin samples. The method further includes calibrating the apparatus based on a correlation between the aspect ratios and the shape factors. Unless otherwise specified, kaolin samples as describe herein may include various minerals and other impurities including but not limited to kaolinite, mica, smectite, titania (e.g., anatase), goethite, and iron oxide (e.g., hematite), for example.

According to a further aspect, a method for measuring the shape factor of non-spherical (e.g., platelet-like, rod-like, etc.) particles includes providing an apparatus calibrated by the above-outlined method, providing a fully-deflocculated suspension of the particles, and taking a first conductivity measurement of the particle suspension with the particles having a first form of orientation between points of measurement of the conductivity using the apparatus. The method further includes taking a second conductivity measurement of the particle suspension with the particles having a second form of orientation different from the first form between points of measurement of the conductivity using the apparatus. The method also includes using the difference in the two conductivity measurements as a measure of the shape factor of the particles in suspension.

According to yet a further aspect, a method for measuring the shape factor of non-spherical particles includes providing an apparatus calibrated by the above-outlined method and providing a fully-deflocculated suspension of the particles. The method further includes orienting the particles in the suspension and measuring the conductivity of the oriented particle suspension using the apparatus, allowing the particles to become randomly oriented and measuring the conductivity of the randomly oriented particle suspension using the apparatus, and using a difference in the two conductivity measurements to determine the shape factor of the particles in the suspension.

According to still a further aspect, a method of providing a parameter indicative of a weight average aspect ratio of non-spherical shaped particles includes providing an apparatus calibrated by the above-outlined method and providing a fully-deflocculated suspension of the particles. The method further includes orienting the particles in the suspension and measuring the conductivity of the oriented particle suspension using the apparatus, and allowing the particles to become randomly oriented and measuring the conductivity of the randomly oriented particle suspension using the apparatus. The method further includes using a difference in the two conductivity measurements as a parameter indicating the weight average aspect ratio of the particles in the suspension.

According to yet a further aspect, a method of producing a fluid suspension of particles having a desired weight average aspect ratio includes providing an apparatus calibrated by the above-outlined method and providing a first fully deflocculated suspension of particles having an average aspect ratio greater than the desired weight average aspect ratio. The method further includes providing a second fully-deflocculated suspension of particles having an average aspect ratio lower than the desired weight average aspect ratio and blending a quantity of one of the suspensions with the other suspension in successive steps. The method further includes, after each blending step, using the apparatus to determine the average aspect ratio of the blended suspension by taking a first conductivity measurement of the particle suspension with the particles having a first form of orientation between points of measurement of the conductivity. The method further includes using the apparatus to take a second conductivity measurement of the particle suspension with the particles having a second form of orientation different from the first form between points of measurement of the conductivity. The method further includes using the difference between the two conductivity measurements as a measure of the average aspect ratio of the particles in suspension and repeating the blending and average aspect ratio determination steps until the determination indicates that the average aspect ratio corresponds to the desired weight average aspect ratio.

According to still a further aspect, a method for measuring the shape factor of non-spherical particles includes providing an apparatus calibrated by the above-outlined method, providing a fully-deflocculated suspension of the particles, and causing the particles in the suspension to orientate generally in one direction. The method further includes measuring the conductivity of the particles suspension substantially in said one direction, simultaneously or substantially simultaneously measuring the conductivity of the particle suspension in a direction transverse to said one direction, and using the difference in the two conductivity measurements as a measure of the shape factor of the particles in suspension.

According to yet another aspect, a method for calibrating an apparatus for measuring shape factor includes determining aspect ratios for each of a plurality of kaolin samples and measuring the shape factors of each of the plurality of kaolin samples using the apparatus, wherein each of the kaolin samples includes potassium oxide in an amount less than about 0.1% by weight of each of the kaolin samples, magnesium oxide in an amount less than about 0.5% by weight of each of the kaolin samples, calcium oxide in an amount less than about 0.1% by weight of each of the kaolin samples, sulfur in an amount less than about 0.06% by weight of each of the kaolin samples, iron oxide in an amount less than about 1.0% by weight of each of the kaolin samples, sodium oxide in an amount less than or equal to about 0.2% by weight of each of the kaolin samples, aluminum oxide in an amount ranging from about 38.3% to about 39.0% by weight of each of the kaolin samples, silicon oxide in an amount ranging from about 44.3% to about 44.8% by weight of each of the kaolin samples, and LOI ranging from about 13.8% by weight to about 14.4% by weight. The method further includes calibrating the apparatus based on a correlation between the aspect ratios and the shape factors.

According to still a further aspect, standard samples for calibrating an apparatus for measuring shape factor may include a plurality of kaolin samples, wherein linear regression of the shape factors as a function of the aspect ratios results in a statistically significant correlation of the average aspect ratios with the shape factors resulting in a Y intercept of about 0, a slope of about 1, and an R² value equal to or greater than about 0.75. As used herein, “statistically significant” means a p value less than about 0.1, or less than about 0.01, or less than about 10⁻⁴. For instance, the p value may range from about 0.1, corresponding to a 90% confidence in the results, to 0.01, corresponding to 99% confidence, to even less than 10⁻⁵, corresponding to a confidence level greater than 99.999% in the validity of the statistical model.

It is to be understood that both the foregoing general description and the following detailed description are exemplary and explanatory only and are not restrictive of the invention, as claimed.

### BRIEF DESCRIPTION OF THE DRAWINGS

FIG. 1 shows an example of a platelet-like particle;

FIG. 2 is a diagrammatic representation of a suspension of ellipsoidal particles flowing along a conduit;

FIG. 3 is a graph showing a relationship between the difference between two conductivity measurements, each taken between two points in the suspension but in mutually perpendicular directions, and the aspect ratio;

FIG. 4 shows an exemplary arrangement of electrodes in a first embodiment of an apparatus for measuring shape factor;

FIG. 5 is a diagrammatic representation of a cross section of the conduit shown in FIG. 2 showing radial symmetry of orientation of the particles;

FIG. 6 shows an exemplary first tubular vessel;

FIG. 7 shows an exemplary electrode arrangement for a second tubular vessel in a second example of an apparatus for measuring shape factor; and

FIG. 8 is a graph showing shape factor vs. measured aspect ratio for ten kaolin samples A-J.

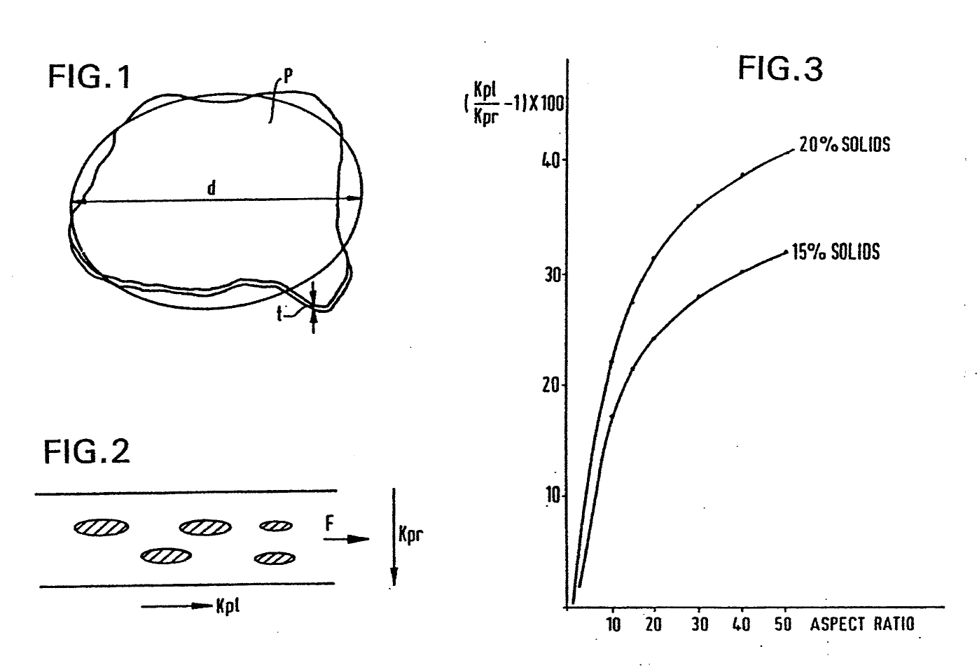

### DESCRIPTION OF EXEMPLARY EMBODIMENTS

Reference will now be made in detail to exemplary embodiments illustrated in the accompanying drawings. Wherever possible, the same reference numbers will be used throughout the drawings to refer to the same or like parts.

An apparatus may be used to obtain a measure of the shape factor of particles in a suspension in accordance with a theoretical treatment given by H. Fricke in an article entitled, “A Mathematical Treatment of the Electric Conductivity and Capacity of Disperse Systems”, (Phys. Rev. 24, 1924, pp. 575-587), which discusses the conductivity of randomly orientated ellipsoidal particles in a suspension. According to Fricke, if ellipsoidal particles are orientated in a shear gradient, for example, with their major axial dimension aligned as shown in FIG. 2, and the conductivity is measured in a direction parallel (Kₚₗ) and perpendicular (Kₚᵣ) to the particle major axial dimension, then the relationship between the directional conductivity and the shape factor of the particles is given by the following equations:

$$\frac{{K}_{pl}}{{K}_{pr}} = \frac{1 + 2 ( \frac{{K}_{2}}{{K}_{1}} ) ( \frac{R}{1 - R} ) B}{1 + 2 ( \frac{R}{1 - R} ) B} \times \frac{1 + ( \frac{R}{1 - R} ) C}{1 + ( \frac{{K}_{2}}{{K}_{1}} ) ( \frac{R}{1 - R} ) C} ,$$

where R=volume fraction occupied by the particles in suspension, K₂=particle conductivity, K₁=fluid phase conductivity, and

$$B = \frac{1}{2 + M ( {K}_{2} / {K}_{1} - 1 )} and$$

$$C = \frac{1}{1 + ( 1 - M ) ( {K}_{2} / {K}_{1} - 1 )} .$$

The term M, which occurs in B and C, contains the information concerning particle shape and is given, for oblate spheroids, by:

M=(Φ−sin 2 Φ/2)/sin³ Φ
where cos Φ=a/b
with
2a=minor axis (thickness) of the particles, and
2b=2c=major axis (diameter) of the particles.

If a value for the term K₂/K₁ is known, or can be assumed, then the first equation results in the measured quantity Kₚₗ/Kₚᵣ being indicative of the average aspect ratio (a/b) of the particles.

The first equation indicates that the measured quantity Kₚₗ/Kₚᵣ is independent of the particle size (i.e., on the major axis diameter 2b), but depends on the ratio (a/b). If this ratio varies within the material in suspension, then a single mean value will be obtained by the method described above. This single mean value will be based on the relative volumes occupied by the various component particles because the first equation indicates that it is the parameter R that controls the value of Kₚₗ/Kₚᵣ.

In order to illustrate the use of first equation, it is possible to calculate how the value (Kₚₗ/Kₚᵣ−1)×100 changes with aspect ratio values at a given solids concentration in the suspension, as shown in FIG. 3. For this purpose, a value for the parameter K₂/K₁ of 0.12 has been assumed, based on practical experience with the method. It can be seen that as the aspect ratio of a particle increases in value, the change in conductivity values measured in different directions through a suspension of the orientated particles also increases, enabling a value for the average aspect ratio to be estimated. Two different values for the suspension solids concentrations have been included in these calculated examples, namely 15% by weight and 20% by weight, respectively, of solids.

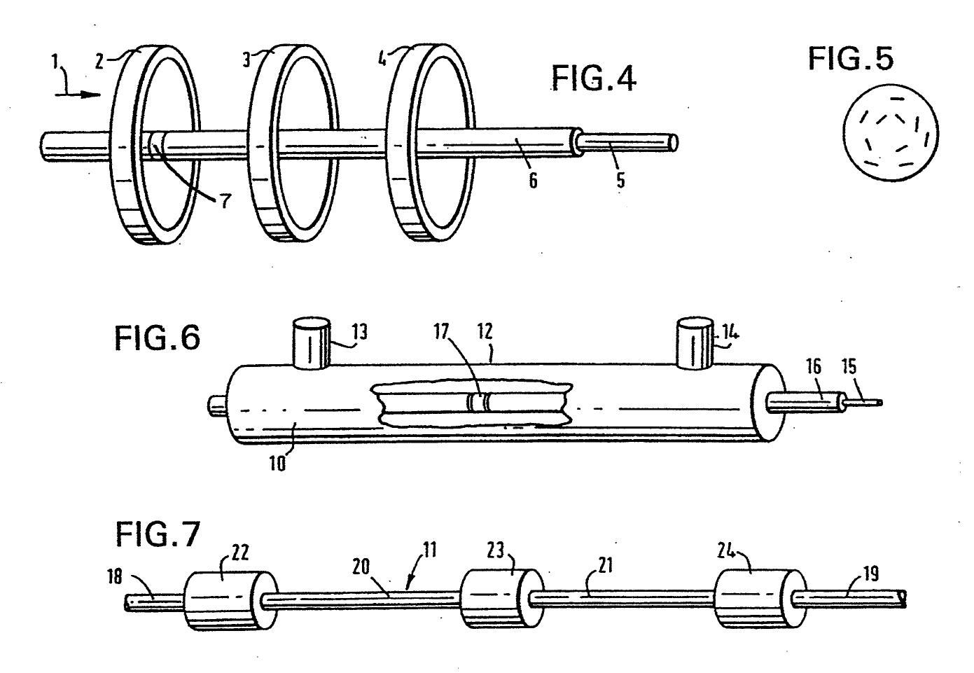

FIG. 4 shows diagrammatically an exemplary arrangement of electrodes that may be used to make conductivity measurements, so as to obtain a measure of the shape factor of particles in an aqueous suspension in accordance with the mathematical treatment given above.

The exemplary apparatus for measuring the conductivity of the solution includes a tubular measuring vessel (not shown), which contains the aqueous suspension. Three annular carbon electrodes 2, 3, and 4 are set in the cylindrical wall of the measuring vessel. A stainless steel rod 5 covered within the measuring vessel substantially completely by a nylon sleeve 6 is fixed along the longitudinal axis of the measuring vessel. At the center of the annular electrode 2, a gap is left in the sleeve 6, and the gap is filled by a carbon collar fitting tightly on the stainless steel rod 5, the carbon collar forming a fourth electrode 7.

An aqueous suspension of non-spherical particles flows in the direction of the arrow 1 through the measuring vessel. The velocity gradient in the flowing suspension increases linearly with radial distance from the longitudinal axis of the measuring chamber, causing the particles to align parallel to the axis according to well known behavior. When the particles have a shape that approximates that of oblate spheroids, the major axial dimension will be parallel to the longitudinal axis and, on average, perpendicular to the radial direction. The orientation of particles under these shear field conditions is represented diagrammatically in FIG. 5, which shows a transverse cross section through the measuring vessel. Thus, measurements of conductivity made in the stream of flowing suspension between the axial electrode 7 and the annular electrode 2 provide the conductivity in a direction perpendicular to the major axial dimension of the particles (Kₚᵣ), and between the central annular electrode 3 and the two outer annular electrodes 2 and 4, which are connected together to provide the conductivity in the direction generally parallel to the flow direction and to the major axial dimension of the particles (Kₚₗ).

If the case of a suspension flowing through a tubular measuring chamber is compared with the case of random orientation of the particles, as occurs, for example, in a non-flowing suspension, the conductivity Kₚᵣ is higher in the flowing state, and the conductivity Kₚₗ is lower than in the non-flowing state.

FIGS. 6 and 7 show a further example of an apparatus for measuring shape factor. In these examples, an aqueous suspension of non-spherical particles is caused to flow at a substantially uniform velocity through a first measuring vessel 10 (FIG. 6) and then through a second measuring vessel 11 (FIG. 7). Measuring vessel 10 comprises a cylindrical shell 12 of stainless steel provided with an inlet 13 and an outlet 14 for the flowing suspension. A stainless steel rod 15 is fixed along the longitudinal axis of the vessel and is covered within the measuring vessel 10 substantially completely with a nylon sleeve 16. At the mid-point of the measuring vessel, a gap is left in the sleeve 16, and the gap is filled with a carbon collar fitting tightly on the stainless steel rod 15, which forms an electrode 17.

The second measuring vessel 11 comprises a nylon inlet tube 18 and a nylon outlet tube 19, and two further equal lengths of nylon tubing 20 and 21. The lengths of tubing are joined together by three cylindrical carbon electrodes 22, 23, and 24, each of which has an axial bore into which the nylon tubing fits tightly. Tubes 18 and 20 each fit into the bore of electrode 22, with a gap left between the two ends of the tubes within the bore. Tubes 20 and 21 each fit in a similar manner into the bore of electrode 23, and tubes 21 and 19 fit into the bore of electrode 24.

The conductivity in the direction perpendicular to the major axial dimension of the particles (Kₚᵣ) is measured between the axial electrode 17 and the stainless steel shell 12. The conductivity in the direction parallel to the major axial dimension of the particles (Kₚₗ) is measured between the central electrode 23, and the two outer electrodes 22 and 24 are connected to each other. The two conductivity measurements are then used as indicated above to provide a measure of the average aspect ratio, or shape factor, of the particles in the suspension.

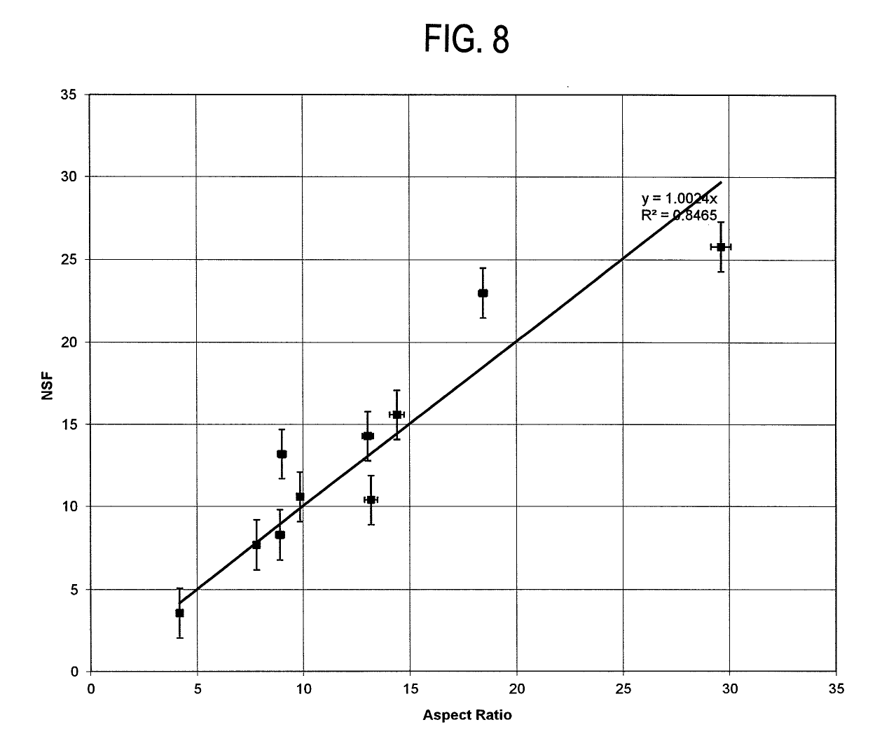

As shown in FIG. 8, it has been surprisingly determined that there is about a 1:1 correlation between measured aspect ratio and shape factor for kaolin samples having a potassium oxide content less than about 0.1 wt. %, which typically corresponds to a low mica content. Such kaolin samples may be described as substantially pure. As used herein, “substantially pure kaolin” refers to beneficiated near white or white clay substance comprised of minerals of the kaolin family such as kaolinite, halloysite, nacrite, and dickite, and possibly naturally occurring impurities such as vermiculite, mica (e.g., biotite, muscovite), feldspar, quartz, and organic matter, yet which are devoid of or substantially devoid of iron sulfide (e.g., pyrite), iron oxide (e.g., hematite), aluminum oxide, aluminum hydroxide (e.g., gibbsite), aluminum sulfate (e.g., alunite), anatase, mineraloids, and alumina silicate gels. In some embodiments, substantially pure kaolin samples may have a potassium oxide content of less than about 0.1 wt. %, in other embodiments less than about 0.05 wt. %, and still other embodiments less than about 0.01 wt. %.

In certain embodiments, substantially pure kaolin samples may have a magnesium oxide content of less than about 0.5 wt. %, in other embodiments less than about 0.25 wt. %, and still other embodiments less than about 0.05 wt. %. In another embodiment, substantially pure kaolin samples may have a calcium oxide content of less than about 1.0 wt. %, in other embodiments less than about 0.5 wt. %, and still other embodiments less than about 0.1 wt. %. In yet another embodiments, substantially pure kaolin samples may have a sulfur content of less than about 0.06 wt. %, in other embodiments less than about 0.03 wt. %, and still other embodiments less than about 0.01 wt. %. In some embodiments, substantially pure kaolin samples may have an iron oxide as accessory iron-bearing minerals rather than being in the kaolinite structure content of less than about 1.0 wt. %, in other embodiments less than about 0.5 wt. %, and still other embodiments less than about 0.1 wt. %. In other embodiments, substantially pure kaolin samples may have a sodium oxide content of less than about 0.2 wt. %, in other embodiments less than about 0.1%, and still other embodiments less than about 0.01 wt. %.

In certain embodiments, substantially pure kaolin samples may have an aluminum oxide content ranging from about 38.2 wt. % to about 39.1 wt. % and in other embodiments ranging from about 38.3 wt. % to about 39.0 wt. %. In some embodiments, substantially pure kaolin samples may have a silicon oxide content ranging from about 43.0 wt. % to about 46.1 wt. % and in other embodiments ranging from about 44.3 wt. % to about 44.8 wt. %. In some instances, substantially pure kaolin samples may have a loss-on-ignition (LOI) at 1050° C. ranging from about 13.7 wt. % to about 14.5 wt. % and in other embodiments ranging from about 13.8 wt. % to about 14.4 wt. %.

Tables 1 and 2 below show the numerical data for ten beneficiated sedimentary kaolin samples A-J used to generate the graph shown in FIG. 8. The sample mineralogy was determined by x-ray fluorescence. The x-ray fluorescence was performed using a Siemens 3000 X-ray Fluorescence Spectrometer. The samples were prepared for measurement by forming pressed pellets. The pressed pellets were formed by grinding a supply of the kaolin sample and pressing the ground kaolin into pellets using a Spex 3624B Hydraulic Press. Thereafter, the pellets were loaded into sample holders for placement in the spectrometer. The sample holders were loaded into the spectrometer, and the spectrometer was activated to analyze the samples.

The LOI of each sample at 1050° C. was measured to determine the content of structural water, carbon dioxide, and other volatiles within the samples. In this exemplary manner, the amount of material lost when a dry sample is fused at 1050° C. was determined. The weight loss may be calculated and added to the elemental oxide concentrations and limes to determine the chemical analysis of silicates, carbonates, and limes for major elemental oxide content.

To determine the LOI for the samples, the samples were transferred into an aluminum pan and dried in an oven at 120° C. for two hours. Immediately following drying, the samples were placed in a vacuum dessicator and allowed to reach room temperature before being weighed in porcelain crucibles. Prior to loading the samples into the porcelain crucibles, the porcelain crucibles were ignited for ten minutes at 1050° C. and allowed to cool for thirty seconds before being transferred to the vacuum dessicator, where they were allowed to cool to room temperature. Thereafter, each of the crucibles was weighed using an analytical balance (accurate to 0.0001 grams), and the weights of each of the crucibles was recorded. Thereafter, 1.0000 to 1.50000 grams (using as a target 1.2500 g) of dried kaolin sample was transferred to each of the weighed crucibles, and each crucible and sample pair was weighed. Each weighed crucible and sample pair was thereafter transferred to a furnace and ignited for one hour at 1050° C. The crucible and sample pairs were removed from the furnace and allowed to cool for 45 seconds before being placed into the vacuum dessicator. Each crucible and sample pair was removed from the vacuum dessicator and weighed. The percent loss on ignition was calculated for each sample according to the following formula:

% LOI=1−(W_{CSI}−W_{C})/W_{S}×100,
where W_{CSI} is the weight of the crucible and sample pair after ignition;
W_{C} is the weight of the crucible; and
W_{S} is the weight of the unfired sample.

TABLE 1

| | Aspect | | | | | |
|---|---|---|---|---|---|---|
| Sample ID | Ratio | Al₂O₃ | K₂O | MgO | SiO₂ | Shape Factor |
| A | 7.8 | 38.49 | 0.02 | 0.03 | 44.64 | 7.7 |
| B | 8.9 | 38.98 | 0.03 | 0.03 | 44.29 | 8.3 |
| C | 9.9 | 38.34 | 0.09 | 0.05 | 44.78 | 10.6 |
| D | 14.4 | 38.77 | 0.04 | 0.03 | 44.49 | 15.6 |
| E | 13.0 | 38.88 | 0.02 | 0.03 | 44.41 | 14.3 |
| F | 13.2 | 38.69 | 0.06 | 0.05 | 44.53 | 10.4 |
| G | 29.6 | 38.46 | 0.09 | 0.05 | 44.72 | 25.8 |
| H | 9.0 | 38.87 | 0.05 | 0.05 | 44.38 | 13.2 |
| I | 18.4 | 38.84 | 0.03 | 0.03 | 44.46 | 23 |
| J | 4.2 | 38.69 | 0.02 | 0.03 | 44.44 | 3.6 |

TABLE 2

| | | | | | | LOI at |
|---|---|---|---|---|---|---|
| Sample ID | Na₂O | Fe₂O₃ | P₂O₅ | CaO | S | 1050° C. |
| A | 0.06 | 0.12 | 0.14 | 0.02 | 0.01 | 13.84 |
| B | 0.06 | 0.12 | 0.08 | 0.00 | 0.01 | 13.93 |
| C | 0.18 | 0.89 | 0.19 | 0.01 | 0.03 | 14.10 |
| D | 0.10 | 0.51 | 0.08 | 0.00 | 0.04 | 14.17 |
| E | 0.14 | 0.49 | 0.08 | 0.00 | 0.05 | 14.26 |
| F | 0.18 | 0.57 | 0.13 | 0.09 | 0.03 | 14.34 |
| G | 0.19 | 0.54 | 0.10 | 0.02 | 0.05 | 14.26 |
| H | 0.16 | 0.45 | 0.09 | 0.02 | 0.04 | 14.35 |
| I | 0.20 | 0.46 | 0.08 | 0.00 | 0.04 | 14.21 |
| J | 0.20 | 0.69 | 0.27 | 0.04 | 0.03 | 14.81 |

The aspect ratio data for the ten kaolin samples A-J was obtained by measuring the aspect ratio of each sample using electron microscopy. In particular, the aspect ratio was measured by shadowed electron microscopy, which is a well known method for determining aspect ratio. Using this method, kaolin sample particles were coated with gold at a low angle to produce shadows. The coated particles were photographed at two magnifications, 15,000× and 5,000×. Photos were taken at the 15,000× magnification to cover roughly the same area as the 5,000× photos. The longest dimension, shortest dimension, and shadow length of each particle were measured. The thickness of the particles was calculated by dividing a 1-micron latex calibration sphere diameter by the shadow length. The aspect ratio was determined by dividing the average diameter of each particle by the thickness. The mean and median aspect ratios were calculated. These data points were mass-weighted for statistical calculations. For mass calculations, each particle was assumed to be elliptical, with the longest and shortest dimensions used as the major and minor axes of the ellipse.

The sample mounts were prepared by MVA Scientific Consultants, Inc. Some samples were prepared by drying very dilute suspensions of particles on 3 mm TEM grids, which are copper grids supporting a very thin carbon membrane. Measurements were taken with the SEM in the normal secondary electron imaging mode rather than transmitted electron mode.

Some of the measurements were made using samples prepared on a silicon chip combined with SEM imaging, rather than TEM grids. The silicon chips are very rugged, and can be stored and reloaded into the SEM many times with minimal damage.

The aspect ratio measurement method assumes that the substrate the coating is applied to is absolutely flat. Any deviation in flatness will produce measurement errors. To compensate for this error, at least one calibration sphere may be measured in every photograph to recalculate the shadow length to thickness ratio for the particles in that photo. This technique limits the photos to areas where calibration spheres are present. It may be difficult to obtain an even dispersion of calibration spheres when the samples are prepared, and thus, many areas of the grid may have visible kaolin particles that cannot be photographed or measured because no sphere is present for correction of the thickness calibration. This situation reduces the number of measurable particles on the grid. Fewer particles measured results in more measurement error and uncertainty.

The silicon chips address these issues, as they are extremely flat and there is no significant elevation difference from one corner of the chip to the opposite corner. It may be possible to take one or two calibration sphere measurements and to use the calculated shadow-to-thickness ratio for all particles on the chip. Thus, fewer particles are left out of the measurements. More particles measured mean more accurate aspect ratio measurements. The silicon chips also have more useable area per chip, which means many more particles can be measured per sample mount. The chips are 6 mm square and the circular TEM grids are 3 mm in diameter. The useable area of a chip is theoretically 36 square mm, and the useable area of a TEM grid is less than 7.07 square mm. If the number of particles deposited per unit area is the same, a silicon chip may hold as many measurable particles as 5 or 6 TEM grids.

In certain embodiments, a chromium coating may be substituted for the gold coating to produce shadows. The relatively coarse grain size of gold crystals in a gold coating limits the minimum shadow length or thickness that may be measured. Therefore, the size of the grains of the metallic coating may set a limit on the minimum measurable thickness (e.g., clay platelet thickness). Chromium coatings have a finer grain structure, which avoids or mitigates this limitation on minimum thickness measured. In certain embodiments, the shadowing angle may be varied to produce longer shadows to make the measurements easier and more accurate when very thin particulate plates are being measured.

In certain embodiments, determining the aspect ratios comprises measuring from about 180 particles to about 4,000 particles of each of the plurality of kaolin samples. In other embodiments, determining the aspect ratios comprises measuring at least about 500 particles of each of the plurality of kaolin samples. In still other embodiments, determining the aspect ratios comprises measuring greater than about 5,000 particles of each of the plurality of kaolin samples.

By using such methods, it is possible to obtain a high-quality statistical regression fit to the aspect ratio using linear terms in the shape factor. Therefore, it is possible to calibrate an apparatus for measuring shape factor of particles, such as but not limited to, sedimentary kaolin, by correlating aspect ratios of samples of particles with their shape factors as described above to generate a primary calibration curve as shown in FIG. 8. For instance, the linear regression of the shape factors as a function of the aspect ratios results in a statistically significant correlation of the average aspect ratios with the shape factors resulting in a Y intercept of about 0, a slope of about 1, and an R² value equal to or greater than about 0.75. For example, the R² value may be about 0.8, about 0.85, about 0.9, about 0.95, about 0.99, or higher. In some embodiments, the aspect ratio measurement error may be equal to or less than about 2.7, for instance, equal to or less than about 0.5. In certain embodiments, the shape factor error may be equal to or less than about 2.0 units, for instance, equal to or less than about 1.5.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for calibrating an apparatus for measuring shape factor, comprising:
determining aspect ratios for each of a plurality of kaolin samples;
measuring the shape factors of each of the plurality of kaolin samples using the apparatus, wherein each of the kaolin samples includes potassium oxide in an amount less than about 0.1% by weight of each of the kaolin samples; and
calibrating the apparatus based on a correlation between the aspect ratios and the shape factors.

2. The method of claim 1, wherein the each of the kaolin samples is a substantially pure kaolinite sample.

3. The method of claim 1, wherein the plurality of kaolin samples comprises three or more kaolin samples.

4. The method of claim 1, wherein the plurality of kaolin samples comprises four or more kaolin samples.

5. The method of claim 1, wherein the plurality of kaolin samples comprises five or more kaolin samples.

6. The method of claim 1, wherein determining the aspect ratios comprises measuring from 180 to 4,000 particles of each of the plurality of kaolin samples.

7. The method of claim 1, wherein the ratio of each of the aspect ratios to each of the corresponding shape factors of the plurality of kaolin samples is about 1:1.

8. The method of claim 1, wherein the correlation between the aspect ratios and the shape factors is linear.

9. The method of claim 1, wherein each of the kaolin samples includes magnesium oxide in an amount less than about 0.5% by weight of each of the kaolin samples, calcium oxide in an amount less than about 1.0% by weight of each of the kaolin samples, sulfur in an amount less than about 0.06% by weight of each of the kaolin samples, iron oxide in an amount less than about 1.0% by weight of each of the kaolin samples, and sodium oxide in an amount less than or equal to about 0.2% by weight of each of the kaolin samples.

10. A method for measuring the shape factor of non-spherical particles comprising:
providing an apparatus calibrated by the method of claim 1;
providing a fully-deflocculated suspension of the particles;
taking a first conductivity measurement of the particle suspension with the particles having a first form of orientation between points of measurement of the conductivity using the apparatus;
taking a second conductivity measurement of the particle suspension with the particles having a second form of orientation different from the first form between points of measurement of the conductivity using the apparatus; and
using a difference in the two conductivity measurements as a measure of the shape factor of the particles in suspension.

11. The method of claim 10, wherein the points of measurement are the same for each conductivity measurement, and a first field is applied to the particle suspension to cause it to take the first form of orientation.

12. The method of claim 11, wherein a second field in a direction transverse to the first field is applied to the particle suspension to cause it to take the second form of orientation.

13. The method of claim 12, wherein the second form of orientation is a random orientation achieved by allowing time for the particles to settle into random orientation under Brownian motion.

14. The method of claim 10, wherein a field is applied to the particle suspension to cause orientation of particles in a first direction, and wherein the conductivity measurements are taken in two different directions relative to the first direction of orientation so as to produce the first form and the second form of orientation between the points of measurement of conductivity.

15. A method for measuring the shape factor of non-spherical particles, the method comprising:
providing an apparatus calibrated by the method of claim 1;
providing a fully-deflocculated suspension of the particles;
orienting the particles in the suspension and measuring the conductivity of the oriented particle suspension using the apparatus;
allowing the particles to become randomly oriented and measuring the conductivity of the randomly oriented particle suspension using the apparatus; and
using a difference in the two conductivity measurements to determine the shape factor of the particles in the suspension.

16. A method of providing a parameter indicative of a weight average aspect ratio of non-spherical shaped particles, the method comprising:
providing an apparatus calibrated by the method of claim 1;
providing a fully-deflocculated suspension of the particles;
orienting the particles in the suspension and measuring the conductivity of the oriented particle suspension using the apparatus;
allowing the particles to become randomly oriented and measuring the conductivity of the randomly oriented particle suspension using the apparatus; and
using a difference between the two conductivity measurements as a parameter indicating the weight average aspect ratio of the particles in the suspension.

17. A method of producing a fluid suspension of particles having a desired weight average aspect ratio, the method comprising:
providing an apparatus calibrated by the method of claim 1;
providing a first fully deflocculated suspension of particles having an average aspect ratio greater than the desired weight average aspect ratio;
providing a second fully-deflocculated suspension of particles having an average aspect ratio lower than the desired weight average aspect ratio;
blending a quantity of one of the suspensions with the other suspension in successive steps;
after each blending step, using the apparatus to determine the average aspect ratio of the blended suspension by taking a first conductivity measurement of the particle suspension with the particles having a first form of orientation between points of measurement of the conductivity;
using the apparatus to take a second conductivity measurement of the particle suspension with the particles having a second form of orientation different from the first form between points of measurement of the conductivity;
using the difference between the two conductivity measurements as a measure of the average aspect ratio of the particles in suspension; and
repeating the blending and average aspect ratio determination steps until the determination indicates that the average aspect ratio corresponds to the desired weight average aspect ratio.

18. The method of claim 15, wherein a field is applied to the suspension as the method of orienting the particles in their suspension.

19. The method of claim 16, wherein a field is applied to the suspension as the method of orienting the particles in their suspension.

20. The method of claim 17, wherein a field is applied to the particles in their suspension to cause them to take the first form of orientation.

21. The method of claim 12, wherein the first field or the second field is a magnetic field.

22. The method of claim 12, wherein the first field or the second field is an acoustic shear field.

23. The method of claim 12, wherein the first field or the second field is a flow shear field.

24. The method of claim 12, wherein the first field or the second field is an electric field.

25. A method for measuring the shape factor of non-spherical particles, the method comprising:
providing an apparatus calibrated by the method of claim 1;
providing a fully-deflocculated suspension of the particles;
causing the particles in the suspension to orientate generally in a first direction;
using the apparatus, measuring a first conductivity of the particles suspension substantially in the first direction and simultaneously or substantially simultaneously measuring a second conductivity of the particle suspension in a second direction transverse to the first direction; and
using the difference in the two conductivity measurements as a measure of the shape factor of the particles in suspension.

26. The method of claim 25, wherein the particles are caused to orientate generally using a shear field by flowing the suspension through a conduit, whereby the particles orientate such that their long axes are parallel to the direction of flow, which constitutes the first direction.

27. The method of claim 25, wherein measuring the first and second conductivities is alternated and repeated rapidly, and the results averaged.

28. The method of claim 27, wherein measuring the first and second conductivities is performed using AC current.

29. The method of claim 28, wherein measuring the first and second conductivities is affected by using alternate full cycles of an AC square wave source for the alternate conductivity measurements.

30. A method for calibrating an apparatus for measuring shape factor, comprising:
determining aspect ratios for each of a plurality of kaolin samples;
measuring the shape factors of each of the plurality of kaolin samples using the apparatus, wherein each of the kaolin samples includes potassium oxide in an amount less than about 0.1% by weight of each of the kaolin samples, magnesium oxide in an amount less than about 0.5% by weight of each of the kaolin samples, calcium oxide in an amount less than about 0.1% by weight of each of the kaolin samples, sulfur in an amount less than about 0.06% by weight of each of the kaolin samples, iron oxide in an amount less than about 1.0% by weight of each of the kaolin samples, sodium oxide in an amount less than or equal to about 0.2% by weight of each of the kaolin samples, aluminum oxide in an amount ranging from about 38.3% to about 39.0% by weight of each of the kaolin samples, silicon oxide in an amount ranging from about 44.3% to about 44.8% by weight of each of the kaolin samples, and LOI ranging from about 13.8% by weight to about 14.4% by weight; and
calibrating the apparatus based on a correlation between the aspect ratios and the shape factors.

31. Standard samples for calibrating an apparatus for measuring shape factor comprising:
a plurality of kaolin samples, each of the kaolin samples having a respective aspect ratio and a respective shape factor,
wherein linear regression of the shape factors as a function of the aspect ratios results in a statistically significant correlation of the average aspect ratios with the shape factors resulting in a Y intercept of about 0, a slope of about 1, and an R² value equal to or greater than 0.75.

32. The standard samples of claim 31, wherein the p value of the linear regression is less than about 0.1.

33. The method of claim 1, wherein the aspect ratios are determined by preparing kaolin samples and measuring the aspect ratios of the kaolin samples using scanning electron microscopy.
